(19) United States
(12) Patent Application Publication
(10) Pub. No.: US 2003/0198796 A1
(43) Pub. Date: Oct. 23, 2003

(54) Stabilized aqueous crosslinker dispersions

(76) Inventors: Thorsten Rische, Unna (DE); Karin Naujoks, Odenthal (DE); Juergen Meixner, Krefeld (DE); Thomas Feller, Solingen (DE); Eberhard Konig, Leverkusen (DE)

Correspondence Address: BAYER POLYMERS LLC, 100 BAYER ROAD, PITTSBURGH, PA, 15205, US

(21) Appl. No.: 10/341,977

(22) Filed: Jan. 14, 2003

(30) Foreign Application Priority Data
Jan. 17, 2002 (DE) 10201545.7

(51) Int. Cl. B32B 25/02; B32B 25/10; C08F 8/30

(52) U.S. Cl. 428/296.4; 525/124

(57) ABSTRACT

The present invention relates to a water-dispersible crosslinker composition containing

A) at least one hydrophilically-modified, blocked polyisocyanate,

B) at least one stabilizing agent containing

a) at least one amine containing a structural unit corresponding to formula (I)

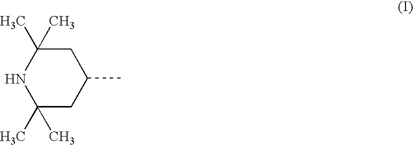

which does not contain hydrazide groups,

b) at least one compound containing a structural unit corresponding to formula (II)

—CO—NH—NH— (II)

and

c) optionally a stabilizing component other than a) and b), and

C) optionally an organic solvent.

The present invention also relates to an aqueous solution or dispersion containing this crosslinker composition, to aqueous coating compositions containing this crosslinker composition and to glass fibers coated with this coating composition.

### FIELD OF THE INVENTION

The present invention relates to novel water-dispersible or water-soluble blocked polyisocyanates which are stabilized against thermal yellowing, and to the preparation and use thereof.

### BACKGROUND OF THE INVENTION

In the coatings industry aqueous one-component (1K) and two-component (2K) polyurethane systems are increasingly being used in combination with blocked isocyanates. As a result of the blocking agents, thermal yellowing of the coatings that are produced frequently occurs, which is undesirable.

Although the prior art discloses blocking agents that cause only very slight thermal yellowing, such as 3,5-dimethylpyrazole, 1,2,4-triazole or ε-caprolactam, they have the disadvantage that they are either too expensive or are not generally usable due to particular product properties. For example, the blocking of HDI-based polyisocyanates with 1,2,4-triazole leads to highly crystalline products, which are unsuitable for use in lacquers and coatings. ε-caprolactam has a significantly higher deblocking temperature in comparison and, therefore, is not suitable for all fields of application.

U.S. Pat. No. 5,216,078 describes a known stabilizing agent which significantly reduces the thermal yellowing of blocked isocyanates, especially of isocyanates blocked with butanone oxime, and which is a hydrazine adduct.

EP-A 0 829 500 describes a combination of compounds as stabilizing agents for blocked polyisocyanates, one of the compounds containing at least one 2,2,6,6-tetramethylpiperidinyl radical, the so-called HALS (hindered amine light stabilizer) radical, and the other containing a hydrazide structure.

It is a disadvantage of the above-mentioned stabilized blocked polyisocyanates, however, that they are suitable only for solvent-borne lacquers and coating compositions and not for aqueous systems.

The preparation of water-dispersible or water-soluble blocked polyisocyanates is known and described, for example, in DE-A 24 56 469 and DE-A 28 53 937. However, the problem of thermal yellowing is not solved in a satisfactory manner in those systems.

An object of the present invention is to provide water-dispersible or water-soluble blocked isocyanates which are adequately stabilized against thermal yellowing and which are suitable for crosslinking of aqueous one-component (1K) and two-component (2K) binders or lacquers, especially based on polyurethane and/or polyacrylate.

It has now been found that polyisocyanates which are blocked and have been rendered hydrophilic and Which are dispersible or soluble in water can also be significantly protected against thermal yellowing with particular combinations of hydrazides and particular sterically hindered amines.

### SUMMARY OF THE INVENTION

The present invention relates to a water-dispersible crosslinker composition containing

A) at least one hydrophilically-modified, blocked polyisocyanate,

B) at least one stabilizing agent containing

a) at least one amine containing a structural unit corresponding to formula (I)

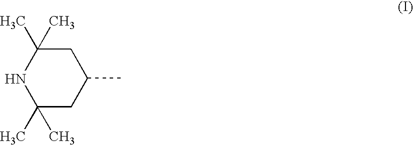

which does not contain hydrazide groups,

b) at least one compound containing a structural unit corresponding to formula (II)

—CO—NH—NH— (II)

and

c) optionally a stabilizing component other than a) and b), and

C) optionally an organic solvent.

The present invention also relates to an aqueous solution or dispersion containing the crosslinker composition according to the invention, wherein the solution or dispersion has a solids content of 10 to 70 wt. %, preferably 20 to 60 wt. % and more preferably 25 to 50 wt. %, and the amount of C) in the overall composition is preferably less than 15 wt. %, more preferably less than 5 wt. %.

The present invention further relates to aqueous coating compositions containing the crosslinker composition according to the invention.

Finally, the present invention relates to glass fibers coated with a coating composition containing the crosslinker composition according to the invention.

### DETAILED DESCRIPTION OF THE INVENTION

Component A) of the crosslinker composition according to the invention is a reaction product of at least one organic polyisocyanate A1) with aliphatically, cycloaliphatically, araliphatically and/or aromatically bound isocyanate groups, an ionic or potential ionic and/or non-ionic compound A2) and a blocking agent A3). Potential ionic within the scope of the invention means that the compound carries a group capable of forming an ionic group.

The crosslinker composition according to the invention contains 78.0 to 99.8 wt. %, preferably 84.0 to 99.6 wt. % and more preferably 90.0 to 99.0 wt. %, of component A); 0.2 to 22.0 wt. %, preferably 0.4 to 16.0 wt. % and more preferably 1.0 to 10.0 wt. %, of component B); wherein the sum of the components is 100 wt. %, based on the solids contents of components A) and B).

Based on the total solids content, the crosslinker composition according to the invention contains 0.1 to 11.0 wt. %, preferably 0.2 to 8.0 wt. % and more preferably 0.5 to 4.0 wt. %, of amines (a) containing the structural unit of formula (I); 0.1 to 11.0 wt. %, preferably 0.2 to 8.0 wt. % and more preferably 0.5 to 4.0 wt. %, of compounds (b) containing the structural unit of formula (II); and 0 to 5.0 wt. % of stabilizers c) which differ from a) and b).

The polyisocyanate component A) has an average NCO functionality of 2.0 to 5.0, preferably 2.3 to 4.5; a content of isocyanate groups (unblocked and blocked) of 5.0 to 27.0 wt. %, preferably 14.0 to 24.0 wt. %; and a content of monomeric diisocyanate of less than 1 wt. %, preferably less than 0.5 wt. %. At least 50%, preferably at least 60% and more preferably at least 70% of the isocyanate groups of polyisocyanate component A) are in blocked form.

Suitable polyisocyanates A1) include those which have uretdione, isocyanurate, allophanate, biuret, iminooxadiazinedione and/or oxadiazinetrione groups. These polyisocyanates are prepared from at least two monomeric aliphatic, cycloaliphatic, araliphatic and/or aromatic diisocyanates as described, for example, in J. Prakt. Chem. 336 (1994) page 185-200.

Suitable diisocyanates for the preparation of polyisocyanates A1) are those having a molecular weight of 140 to 400, which are obtained by phosgenation or by phosgene-free processes, for example by thermal urethane cleavage, and which contain aliphatically, cycloaliphatically, araliphatically and/or aromatically bound isocyanate groups. Examples include 1,4-diisocyanatobutane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis-(isocyanato-methyl)-cyclohexane, 1-isocyanato-3,3,5-trimethyl-5-isocyanatomethyl-cyclohexane (isophorone diisocyanate, IPDI), 4,4′-diisocyanatodicyclo-hexylmethane, 1-isocyanato-1-methyl-4(3)isocyanato-methylcyclohexane, bis-(isocyanatomethyl)-norbornane, 1,3- and 1,4-bis-(2-isocyanato-prop-2-yl)-benzene (TMXDI), 2,4- and 2,6-diisocyanatotoluene (TDI), 2,4′- and 4,4′-diisocyanatodiphenylmethane, 1,5-diisocyanatonaphthalene and mixtures thereof.

Preferred polyisocyanates A1) are those containing only aliphatically and/or cycloaliphatically bonded isocyanate groups. Particularly preferred polyisocyanates A1) are polyisocyanates or polyisocyanate mixtures containing isocyanurate and/or biuret groups and prepared from HDI, IPDI and/or 4,4′-diisocyanatodicyclohexylmethane.

Suitable compounds A2) are ionic or potential ionic and/or non-ionic compounds. Non-ionic compounds include monohydric polyalkylene oxide polyether alcohols containing an average of 5 to 70, preferably 7 to 55, ethylene oxide units per molecule. Compounds A2) are obtained in known manner known by the alkoxylation of suitable starter molecules (e.g., as described in Ullmanns Encyclopädie der technischen Chemie, 4th edition, Volume 19, Verlag Chemie, Weinheim p. 31-38).

Suitable starter molecules include saturated monoalcohols such as methanol, ethanol, n-propanol, isopropanol, n-butanol, isobutanol, sec-butanol, the isomeric-pentanols, hexanols, octanols and nonanols, n-decanol, n-dodecanol, n-tetradecanol, n-hexadecanol, n-octadecanol, cyclohexanol, the isomeric methylcyclohexanols, hydroxymethylcyclo-hexane, 3-ethyl-3-hydroxy-methyloxetane and tetrahydrofurfuryl alcohol; diethylene glycol monoalkyl ethers such as diethylene glycol monobutyl ether; unsaturated alcohols such as allyl alcohol, 1,1-dimethylallyl alcohol and olein alcohol; aromatic alcohols such as phenol, the isomeric cresols and methoxyphenols; araliphatic alcohols such as benzyl alcohol, anisic alcohol and cinnamyl alcohol; secondary monoamines such as dimethylamine, diethylamine, dipropylamine, diisopropylamine, dibutylamine, bis-(2-ethylhexyl)-amine, N-methyl- and N-ethyl-cyclohexylamine and dicyclohexylamine; and heterocyclic secondary amines such as morpholine, pyrrolidine, piperidine and 1H-pyrazole.

Preferred starter molecules are saturated monoalcohols and diethylene glycol monoalkyl ethers. Especially preferred is diethylene glycol monobutyl ether as the starter molecule.

Alkylene oxides suitable for the alkoxylation reaction are preferably ethylene oxide and propylene oxide, which can be used in the alkoxylation reaction in any desired sequence or alternatively in the form of a mixture.

The polyalkylene oxide polyether alcohols are either pure polyethylene oxide polyethers or mixed polyalkylene oxide polyethers, wherein the alkylene oxide units contain at least 30 mol %, preferably at least 40 mol %, of ethylene oxide units. Preferred non-ionic compounds are monofunctional mixed polyalkylene oxide polyethers containing at least 40 mol % of ethylene oxide units and not more than 60 mol % of propylene oxide units.

Other suitable compounds A2) include ionic or potential ionic compounds, which can be used in addition to or instead of the non-ionic compounds. Examples include mono- and di-hydroxycarboxylic acids, mono- and di-aminocarboxylic acids, mono- and di-hydroxysulfonic acids, mono- and di-aminosulfonic acids, mono- and di-hydroxyphosphonic acids and mono- and di-aminophosphonic acids, and their salts. Specific examples include dimethylolpropionic acid, hydroxypivalic acid, N-(2-aminoethyl)-β-alanine (e.g. as sodium salt, KV 1386, commercial available from BASF AG, Ludwigshafen, Del.), 2-(2-amino-ethylamino)-ethanesulfonic acid, ethylenediamine-propyl- or -butyl-sulfonic acid, 1,2- or 1,3-propylene-diamine-β-ethylsulfonic acid, lysine, 3,5-diaminobenzoic acid, the hydrophilic agent according to Example 1 of EP-A 0 916 647 and their alkali and/or ammonium salts; the adduct of sodium bisulfite with butene-2-diol-1,4, polyether sulfonate and the propoxylated adduct of 2-butanediol and NaHSO₃ (e.g. in DE-A 24 46 440, pages 5-9, formulae I-III, U.S. Pat. No. 4,108,814). Also suitable are structural units which can be converted into cationic groups, such as N-methyl-diethanolamine.

Preferred ionic or potential ionic compounds A2) are those which have carboxy or carboxylate and/or sulfonate groups and/or ammonium. groups. Particularly preferred ionic compounds A2) are those which contain carboxyl and/or sulfonate groups as ionic or potential ionic groups, such as the salts of N-(2-aminoethyl)-β-alanine, 2-(2-amino-ethylamino)-ethanesulfonic acid, the hydrophilic agent according to Example 1 of EP-A 0 916 647 and dimethylolpropionic acid.

Component A2) is preferably a mixture of non-ionic and ionic hydrophilic compounds. Mixtures of non-ionic and anionic hydrophilic agents are particularly preferred.

Suitable blocking agents A3) are known and include alcohols, lactams, oximes, malonic esters, alkyl acetoacetates, triazoles, phenols, imidazoles, pyrazoles and amines. Examples include butanone oxime, diisopropylamine, 1,2,4-triazole, dimethyl-1 2,4-triazole, imidazole, malonic acid diethyl ester, acetoacetic ester, acetonexime, 3,5-dimethyl pyrazole, ε-caprolactam and mixtures thereof. Butanoneoxime, 3,5-dimethyl pyrazole and ε-caprolactam are preferably used as blocking agents A3). Particularly preferred blocking agents A3) are butanone oxime and/or ε-caprolactam.

The compositions according to the invention contain a stabilizing agent mixture B) which contains a) an amine containing a structural unit corresponding to formula (I). Suitable compounds a) are those having a 2,2,6,6-tetramethylpiperidinyl radical (HALS ring). The piperidinyl nitrogen of the HALS ring is not substituted and contains no hydrazide structures. Preferred compounds a) are the following:

TABLE 1
Compounds a)

| CAS Reg. No. | Structure |
|---|---|
| 24860-22-8 | 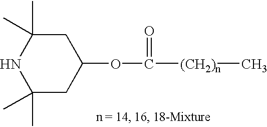 |
| 79720-19-7 | 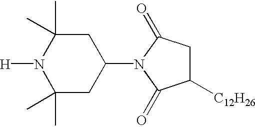 |
| 64338-16-5 | 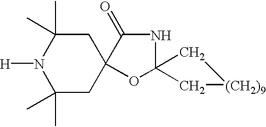 |
| 52829-07-9 | 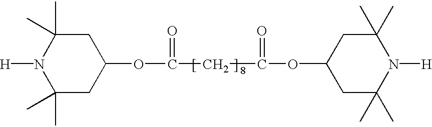 |
| 99473-08-2 | 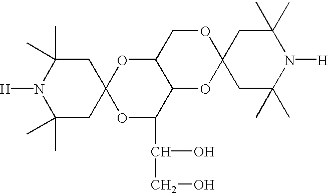 |
| 71029-16-8 | 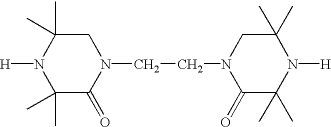 |
| 71878-19-8 | 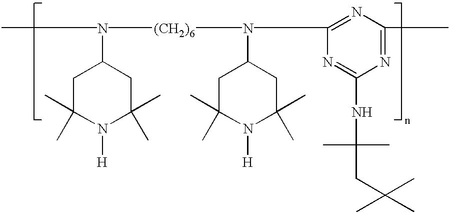 |
| 90751-07-8 | 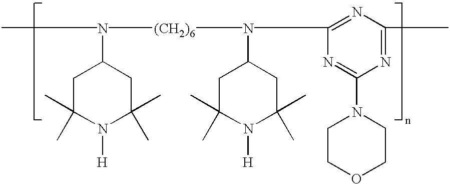 |
| 154636-38-1 | 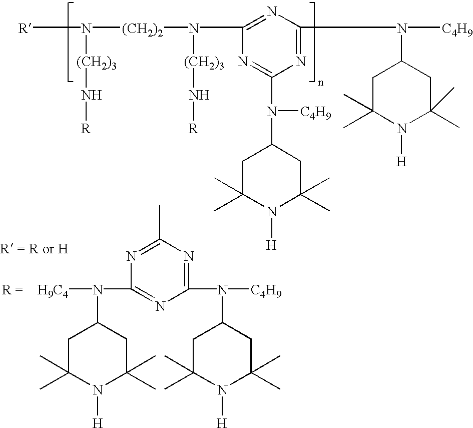 |
| 100631-44-5 | 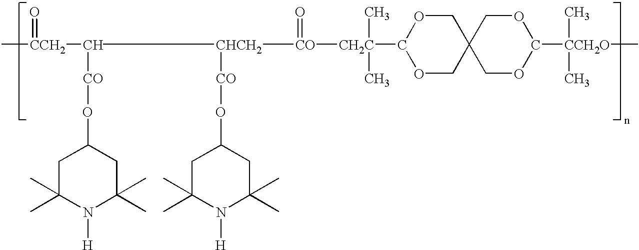 |
| 115810-23-6 | 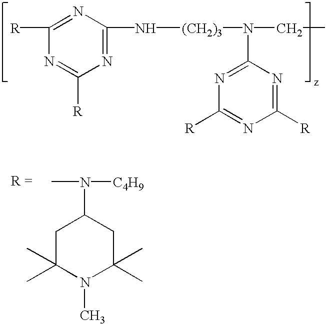 |
| 164648-93-5 | 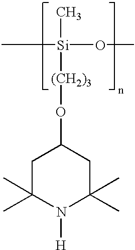 |
| 96204-36-3 | 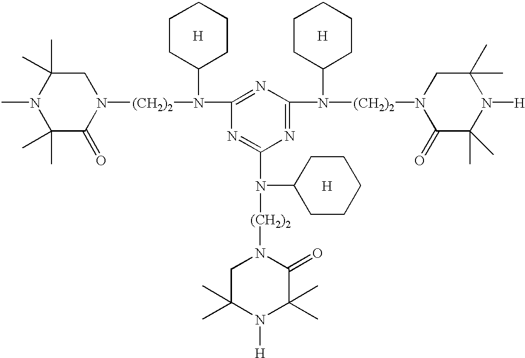 |

Particularly preferred is the compound corresponding to formula (III), which is available as Tinuvin® 770 DF from Ciba Spezialitäten (Lampertheim, Del.):

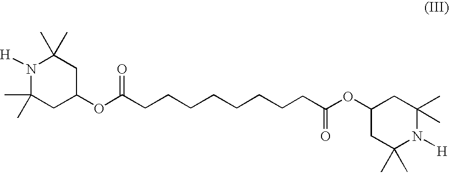

Stabilizing agent B) also contains a compound b) corresponding to formula (II). Suitable compounds b) include acid hydrazides and dihydrazides such as acetic acid hydrazide, adipic acid hydrazide and adipic acid dihydrazide; and hydrazine adducts of hydrazine and cyclic carbonates, such as those described, for example, in EP-A 654 490 (p. 3, line 48 to p. 4, line 3). Preferred are adipic acid dihydrazide and the adduct of 2 moles of propylene carbonate and 1 mole of hydrazine, which corresponds to formula (IV)

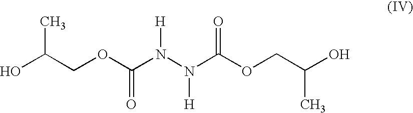

The adduct of 2 moles of propylene carbonate and 1 mole of hydrazine corresponding to formula (IV) is particularly preferred.

Suitable compounds c) include antioxidants such as 2,6-di-tert-butyl-4-methylphenol; UV absorbers of the 2-hydroxyphenyl-benzotriazole type; HALS light stabilizers, which are substituted on the nitrogen atom, such as Tinuvine® 292 (Ciba Spezialitäten GmbH, Lampertheim, Del.); and other commercially available stabilizing agents such as those described, for example, in “Lichtschutzmittel für Lacke” (A. Valet, Vincentz Verlag, Hanover, 1996) and “Stabilization of Polymeric Materials” (H. Zweifel, Springer Verlag, Berlin, 1997, Appendix 3, p. 181-213). Preferred compounds c) are those shown in Table 2:

TABLE 2
Compounds c):

| CAS Reg. No. | Structure |
|---|---|
| 10191-41-0 | 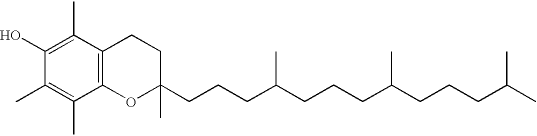 |
| 128-37-0 | 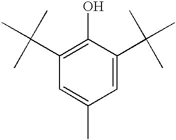 |
| 2082-79-3 | 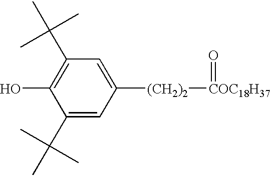 |
| 12643-61-0 | 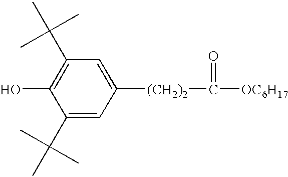 |
| 119-47-1 | 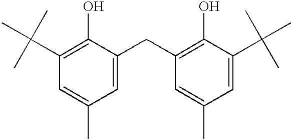 |
| 35074-77-2 | 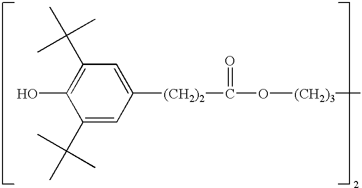 |
| 23128-74-7 | 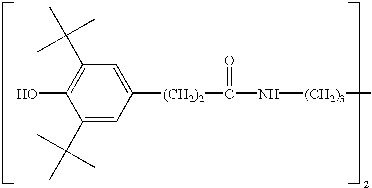 |
| 976-56-7 | 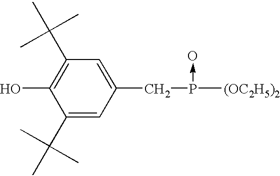 |
| 65140-91-2 | 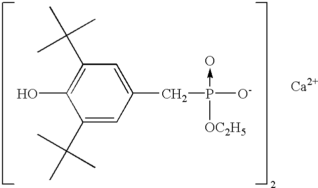 |
| 36443-68-2 | 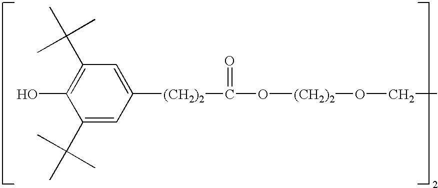 |
| 85-60-9 | 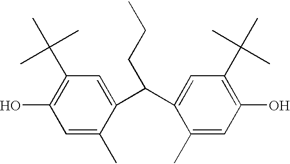 |
| 90498-90-1 | 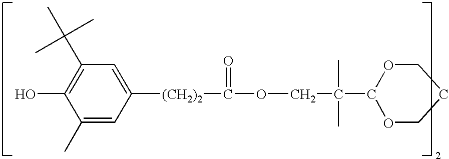 |
| 1709-70-2 | 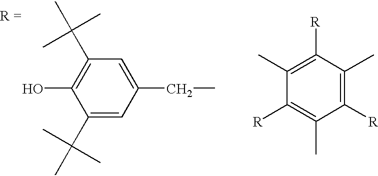 |
| 1843-03-4 | 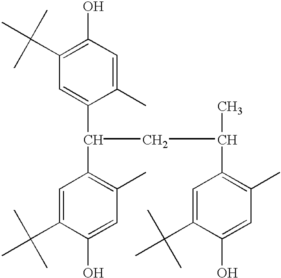 |
| G34137-09-2 | 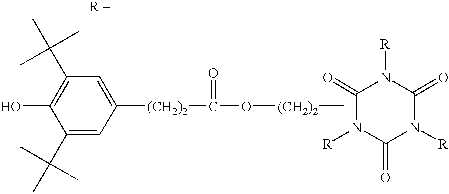 |
| 27676-62-6 | 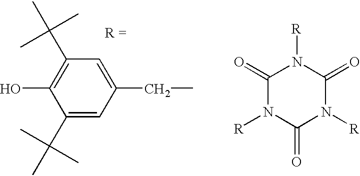 |
| 40601-76-1 | 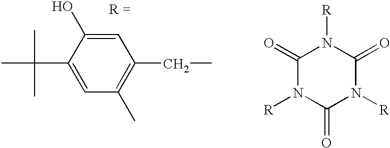 |
| 6683-19-8 | 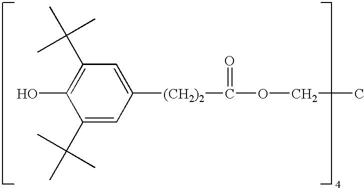 |
| 32509-66-3 | 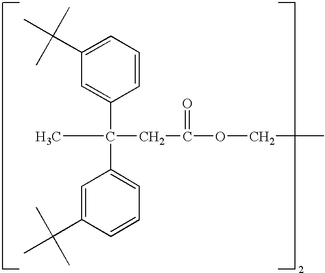 |
| 31851-03-3 | 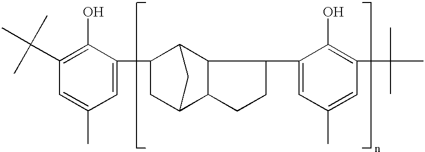 |
| 96-69-5 | 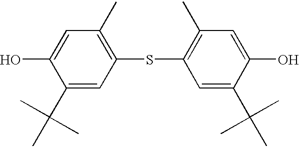 |
| 90-66-4 | 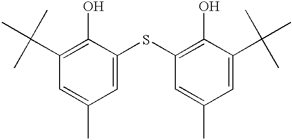 |
| 110553-27-0 | 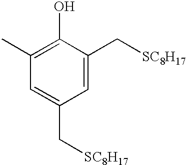 |
| 41484-35-9 | 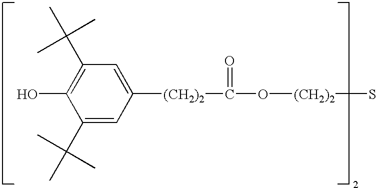 |
| 991-84-4 | 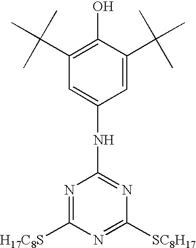 |
| 103-99-1 | 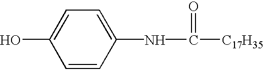 |
| 63843-89-0 | 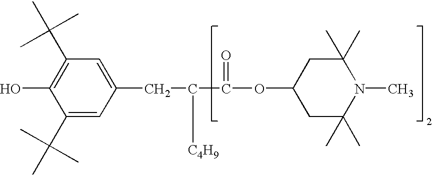 |
| 4221-80-1 | 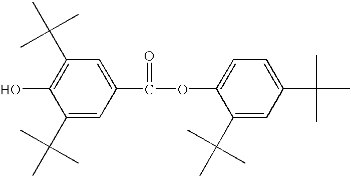 |
| 67845-93-6 | 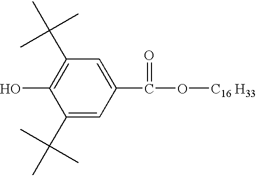 |
| 61167-58-6 | 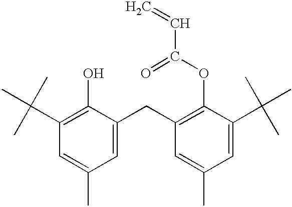 |
| 128961-68-2 | 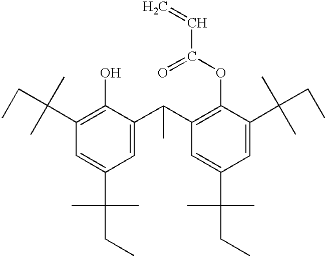 |
| 135-88-6 | 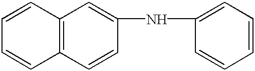 |
| 26780-96-1 | 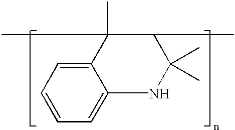 |
| 101-72-4 | 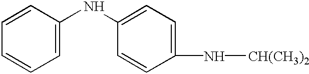 |
| 90-30-2 | 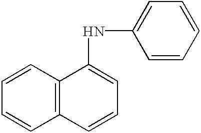 |
| 68411-46-1 | 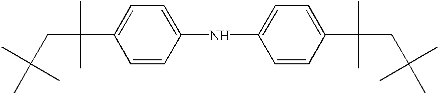 |
| 10081-67-1 | 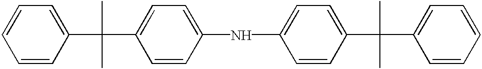 |
| 32687-78-8 | 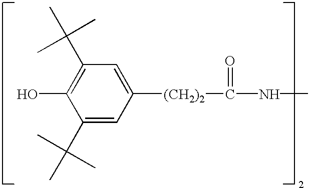 |
| 70331-94-1 | 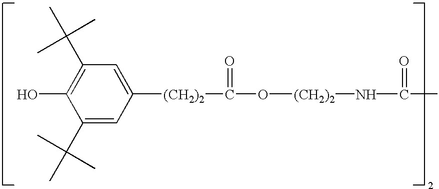 |
| 6629-10-3 | 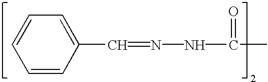 |
| 26523-78-4 | 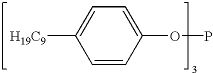 |
| 31570-04-4 | 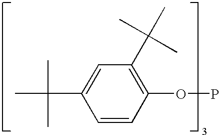 |
| 26741-53-7 | 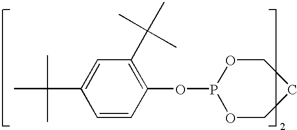 |
| 80693-00-1 | 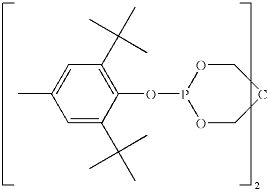 |
| 140221-14-3 | 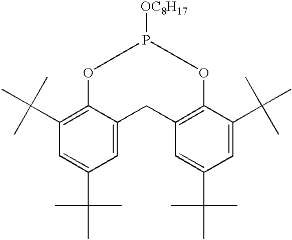 |
| 38613-77-3 | 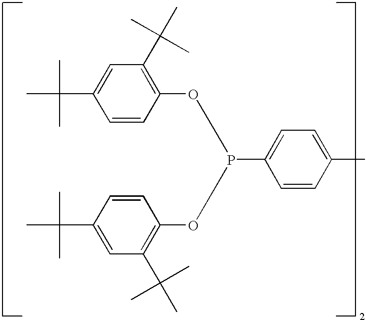 |
| 118337-09-0 | 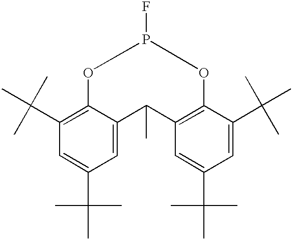 |
| 3806-34-6 | 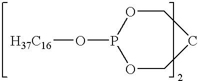 |
| 80410-33-9 | 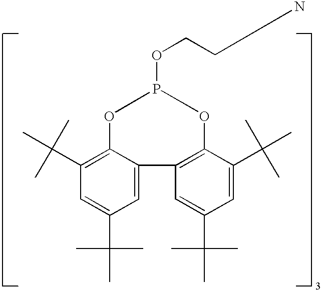 |
| 693-36-7 | 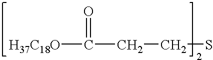 |
| 123-28-4 | 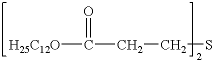 |
| 16545-54-3 | 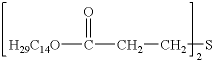 |
| 2500-88-1 | 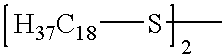 |
| 131-57-7 | 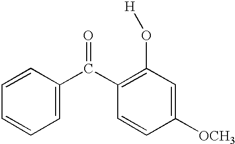 |
| 1843-05-6 | 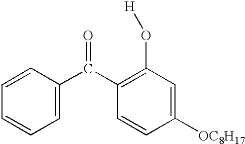 |
| 2985-59-3 | 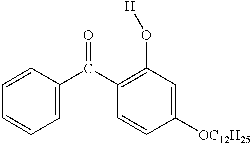 |
| 43221-33-6 | 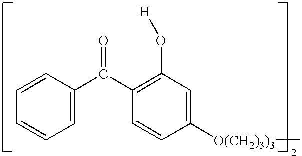 |
| 57472-50-1 | 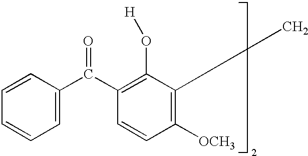 |
| 2440-22-4 | 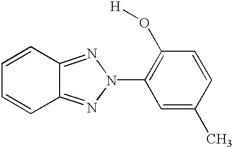 |
| 3147-75-9 | 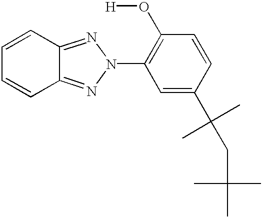 |
| 3896-11-5 | 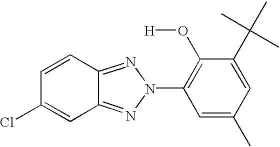 |
| 3846-71-7 | 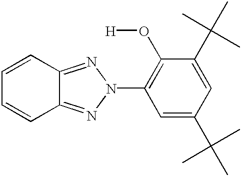 |
| 23328-53-2 | 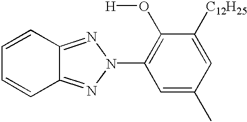 |
| 25973-55-1 | 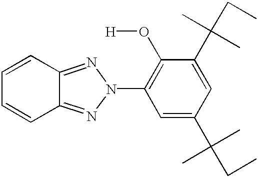 |
| 36437-37-3 | 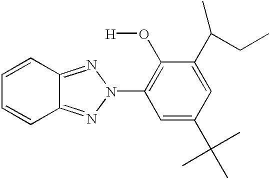 |
| 3864-99-1 | 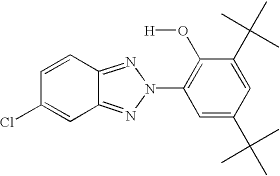 |
| 70321-86-7 | 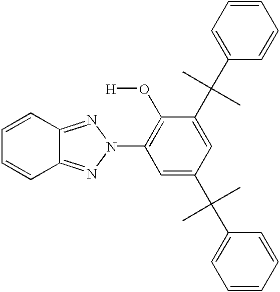 |
| 103597-45-1 | 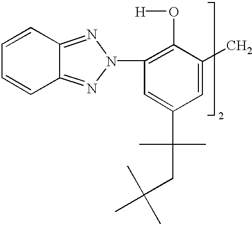 |
| 84268-08-6 | 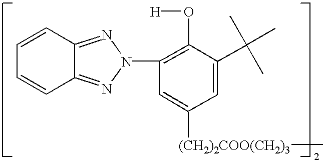 |
| 147315-50-2 | 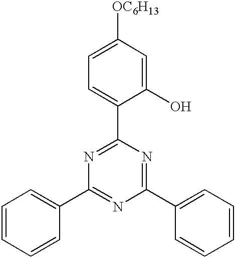 |
| 2725-22-6 | 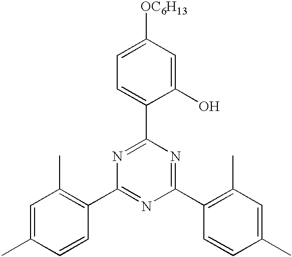 |
| 23949-66-8 | 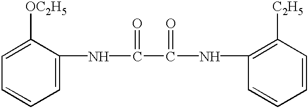 |
| 35001-52-6 | 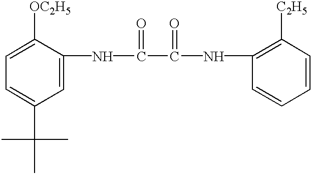 |
| 7443-25-6 | 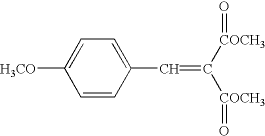 |
| 106917-30-0 | 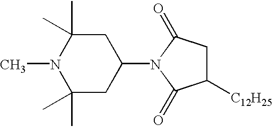 |
| 41556-26-7 | 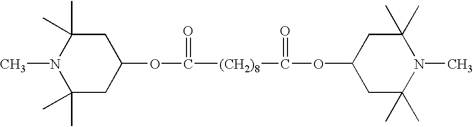 |
| 65447-77-0 | 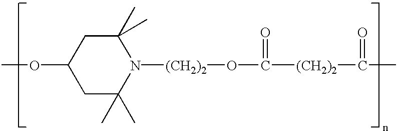 |
| 78276-66-1 | 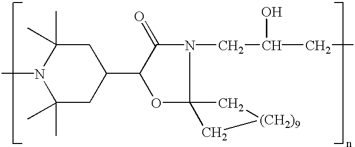 |
| 130277-45-1 | 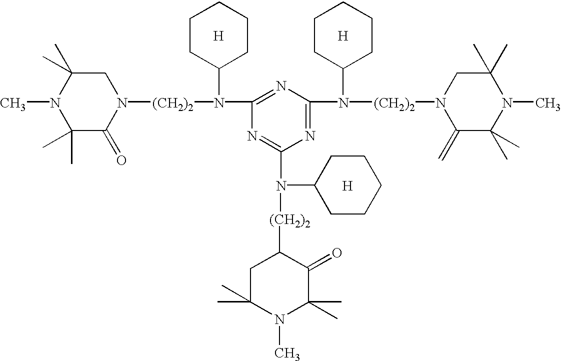 |

Suitable organic solvents C) are known and include ethyl acetate, butyl acetate, 1 -methoxypropyl 2-acetate, 3-methoxy n-butylacetate, acetone, 2-butanone, 4-methyl-2-pentanone, cyclohexanone, toluene, xylene, chlorobenzene and white spirit. Mixtures containing higher substituted aromatic compounds, such as those commercially available under the names Solvent Naphtha, Solvesso® (Exxon Chemicals, Houston, USA), Cypar® (Shell Chemicals, Eschborn, Del.), Cyclo Solo® (Shell Chemicals, Eschborn, Del.), Tolu Sol® (Shell Chemicals, Eschborn, Del.), Shellsol® (Shell Chemicals, Eschborn, Del.), are also suitable.

Other suitable solvents include carbonic acid esters such as dimethyl carbonate, diethyl carbonate, 1,2-ethylene carbonate and 1,2-propylene carbonate; lactones such as β-propiolactone, γ-butyrolactone, ε-caprolactone and ε-methylcaprolactone; propylene glycol diacetate, diethylene glycol dimethyl ether, dipropylene glycol dimethyl ether, diethylene glycol ethyl, butyl ether acetate, N-methylpyrrolidone, N-methylcaprolactam and mixtures thereof.

Preferred solvents include acetone, 2-butanone, 1-methoxypropyl 2-acetate, xylene, toluene, mixtures containing higher substituted aromatic compounds and N-methylpyrrolidone. Acetone, 2-butanone and N-methylpyrrolidone are especially preferred.

The preparation of the water-dispersible crosslinker compositions according to the invention can be carried out according to known methods (e.g. in DE-A 24 564 69, columns 7-8, Examples 1-5 and DE-A 28 539 37 p. 21-26, Examples 1-9).

The water-dispersible crosslinker compositions according to the invention are obtained by the reaction of components A1), A2), A3), a), b) and, optionally, c) in any desired sequence, optionally with the aid of an organic solvent C).

It is preferred to first react A1) with component b) and, optionally, with a portion of non-ionic component A2). Blocking with component A3) is then carried out, followed by addition of a) and, optionally, by reaction with the portion of component A2) containing ionic groups. Organic solvents C) may optionally be added to the reaction mixture. In a further step, component c) is optionally also added.

The preparation of the aqueous solution or dispersion is then carried out by conversion of the water-dispersible crosslinker composition into an aqueous dispersion or solution by addition of water. The organic solvent C) that is optionally used may be removed by distillation following the dispersion.

The amount of water used to prepare the aqueous solution or dispersion containing the crosslinker compositions according to the invention is selected such that the resulting dispersions or solutions have a solids content of 10 to 70 wt. %, preferably 20 to 60 wt. % and more preferably 25 to 50 wt. %.

The crosslinker compositions according to the invention may be used in combination with suitable reaction partners which contain isocyanate-reactive groups Examples include polyurethane and/or polyacrylate dispersions or mixtures or hybrids thereof. Suitable reaction partners also include low molecular weight amines, which can be processed, in solution in water, to form coating compositions that are crosslinkable by heat and can be processed from the aqueous phase. Also, the crosslinker compositions according to the invention may also be incorporated into one-component binders, such as polyurethane and/or polyacrylate dispersions and polyurethane-polyacrylate hybrid dispersions.

It is also possible to use the aqueous solutions or dispersions containing the crosslinker compositions according to the invention without the addition of a further reaction partner, for example, for the impregnation of substrates that contain isocyanate-reactive groups.

The coating compositions containing the crosslinker compositions according to the invention are applied to a suitable substrate by known methods, such as by means of doctor blades, spray or roller applicators, or wire doctors.

Suitable substrates include metal, wood, glass, glass fibres, carbon fibers, stone, ceramic minerals, concrete, rigid and flexible plastics, woven and nonwoven textiles, leather, paper, hard fibers, straw and bitumen. The substrates may optionally be provided with conventional primers prior to coating. Preferred substrates are glass fibers, carbon fibers, metals, textiles and leather. A particularly preferred substrate is glass fibers.

Preference is given to the use of the crosslinker compositions according to the invention in glass fiber sizes. The dispersions can be used on their own or, preferably, together with binders, such as polyurethane dispersions, polyacrylate dispersions, polyurethane-polyacrylate hybrid dispersions, polyvinyl ether and polyvinyl ester dispersions, polystyrene and polyacrylonitrile dispersions. The crosslinkers according to the invention may also be used in admixture with other blocked polyisocyanates and amino crosslinker resins, such as melamine resins.

The crosslinker compositions according to the invention or the sizes produced therewith may contain known additives such as antifoaming agents, thickeners, flow agents, dispersion aids, catalysts, antiskinning agents, antisettling agents, emulsifiers, biocides, adhesion promoters (for example based on the known low or higher molecular weight silanes), lubricants, wetting agents and antistatic agents.

The sizes can be applied by any desired methods, for example by means of suitable apparatus, such as spray or roller applicators. They can be applied to the glass filaments drawn at high speed from spinning nozzles immediately after they have solidified and before they are rolled up. It is also possible to apply the size to the fibers in an immersion bath after the spinning process. The sized glass fibers can be processed further in either wet or dry form, for example to glass for cutting. Drying of the end product or intermediate product takes place at temperatures of 80 to 250° C. Drying is understood to mean not only the removal of other volatile constituents but also, for example, solidification of the constituents of the size. The amount of size, based on the sized glass fibers, is 0.1 to 4 wt. %, preferably 0.2 to 2 wt. %.

Both thermoplastic polymers and duromeric polymers can be used as matrix polymers.

The invention is further illustrated but is not intended to be limited by the following examples in which all parts and percentages are by weight unless otherwise specified.

### EXAMPLES

Hydrophilic agent KV 1386 (BASF AG, Ludwigshafen, Del.): Solution of Natrium-N-(2-aminoethyl)-β-alaninate in water (solid content: 40%)

Determination of thermal yellowing:

The crosslinker compositions listed below were applied in a wet layer thickness of 120 μm to test sheets coated with a commercially available white basecoat from Spies & Hecker. The test sheets were dried for 30 minutes at room temperature and then for 30 minutes at 170° C. in a drying cabinet. Color measurement was then carried out by the CIELAB method. The higher the resulting positive b* value, the more yellow the discoloration of the coating.

### Example 1 (according to the invention)

1445.7 g of a biuret group-containing polyisocyanate prepared from 1,6-diisocyanatohexane (HDI) and having an NCO content of 23.0% were placed in a reaction vessel at 40° C. Over a period of 10 minutes 1215.0 g of polyether LB 25 (Bayer AG, DE, monofunctional polyether based on ethylene oxide/propylene oxide having a number average molecular weight of 2250, OH no. 25) and 16.5 g of the hydrazine adduct of formula IV (reaction product of 1 mole of hydrazine hydrate and 2 moles of propylene carbonate, molecular weight of 236) were metered in with stirring. The reaction mixture was then heated to 90° C. and stirred at that temperature until the theoretical NCO value was reached. After cooling to 65° C., 628.1 g of butanone oxime were added dropwise over a period of 30 minutes, with stirring, such that the temperature of the mixture did not exceed 80° C. 16.5 g of Tinuvin® 770 DF (Ciba Spezialitäten GmbH, Lampertheim, Del.) were then added, stirring was continued for a further 10 minutes, and the reaction mixture was cooled to 60° C. A dispersion was prepared by the addition of 7751.0 g of water (20° C.) at 60° C. over a period of 30 minutes. Stirring was carried out for a further 1 hour at 40° C. An aqueous dispersion of the blocked polyisocyanate that was stable to storage and had a solids content of 30.0% was obtained.

### Example 2: (comparison example)

677.6 g of a biuret group-containing polyisocyanate prepared from 1,6-diisocyanatohexane (HDI) and having an NCO content of 23.0% were placed in a reaction vessel at 40° C. Over a period of 10-minutes 558.9 g of polyether LB 25 (Bayer AG, DE, monofunctional polyether based on ethylene oxide/propylene oxide having a number average molecular weight of 2250, OH no. 25) were metered in with stirring. The reaction mixture was then heated to 90° C. and stirred at that temperature until the theoretical NCO value was reached. After cooling to 65° C., 274.5 g of butanone oxime were added dropwise over a period of 30 minutes, with stirring, such that the temperature of the mixture did not exceed 80° C. 20.1 g of adipic acid dihydrazide were then added at 65° C. in 5 minutes, and the reaction mixture was cooled to 60° C. A dispersion was prepared by the addition of 3390.5 g of water (T=20° C.) at 60° C. over a period of 30 minutes. Stirring was carried out for a further 1 hour at 40° C. An aqueous dispersion of the blocked polyisocyanate that was stable to storage and had a solids content of 30% was obtained.

### Example 3: (comparison example)

147.4 g of a biuret group-containing polyisocyanate prepared from 1,6-diisocyanatohexane (HDI) and having an NCO content of 23.0% were placed in a reaction vessel at 40° C. Over a period of 10 minutes 121.0 g of polyether LB 25 (Bayer AG, DE, monofunctional polyether based on ethylene oxide/propylene oxide having a number average molecular weight of 2250, OH no. 25) were metered in with stirring. The reaction mixture was then heated to 90° C. and stirred at that temperature until the theoretical NCO value was reached. After cooling to 65° C., 62.8 g of butanone oxime were added dropwise over a period of 30 minutes, with stirring, such that the temperature of the mixture did not exceed 80° C. 1.7 g of Irganox® 245 (Ciba Spezialitätten GmbH, Lampertheim, Del.) and 25 1.7 g of Tinuvin® 765 (Ciba Spezialitäten GmbH, Lampertheim, Del.) were then added. Stirring was continued for 10 minutes, and the reaction mixture was cooled to 60° C. A dispersion was prepared by the addition of 726.0 g of water (20° C.) at 60° C. over a period of 30 minutes. Stirring was carried out for a further 1 hour at 40° C. An aqueous dispersion of the blocked polyisocyanate that was stable to storage and had a solids content of 31.4% was obtained.

### Example 4: (comparison example)

5 147.4 g of a biuret group-containing polyisocyanate prepared from 1,6-diisocyanatohexane (HDI) and having an NCO content of 23.0% were placed in a reaction vessel at 40° C. Over a period of 10 minutes 121.0 g of polyether LB 25 (Bayer AG, DE, monofunctional polyether based on ethylene oxide/propylene oxide having a number average molecular weight of 2250, OH no. 25) were metered with stirring. The reaction mixture was then heated to 90° C. and stirred at that temperature until the theoretical NCO value was reached. After cooling to 65° C., 62.8 g of butanone oxime were added dropwise over a period of 30 minutes, with stirring, such that the temperature of the mixture did not exceed 80° C. A dispersion was prepared by the addition of 726.0 g of water (T=20° C.) at 60° C. over a period of 30 minutes. Stirring was carried out for a further 1 hour at 40° C. An aqueous dispersion of the blocked polyisocyanate that was stable to storage and had a solids content of 30.0% was obtained.

### Example 5: (comparison example)

147.4 g of a biuret group-containing polyisocyanate prepared from 1,6-diisocyanatohexane (HDI) and having an NCO content of 23.0% were placed in a reaction vessel at 40° C. Over a period of 10 minutes 121.0 g of polyether LB 25 (Bayer AG, DE, monofunctional polyether based on ethylene oxide/propylene oxide having a number average molecular weight of 2250, OH no.25) and 1.7 g of the hydrazine adduct of formula IV (reaction product of 1 mole of hydrazine hydrate and 2 moles of propylene carbonate, molecular weight of 236) were metered in with stirring. The reaction mixture was then heated to 90° C. and stirred at that temperature until the theoretical NCO value was reached. After cooling to 65° C., 62.8 g of butanone oxime were added dropwise over a period of 30 minutes, with stirring, such that the temperature of the mixture did not exceed 80° C. 1.7 g of Tinuvin 765 were then added, stirring was carried out for a further 10 minutes, and the reaction mixture was cooled to 60° C. A dispersion was prepared by the addition of 726.0 g of water (20° C.) at 60° C. over a period of 30 minutes. Stirring was carried out for a further 1 hour at 40° C. An aqueous dispersion of the blocked polyisocyanate that was stable to storage and had a solids content of 30% was obtained.

TABLE 3
Butanoneoxime-blocked crosslinker compositions containing
different stabilizers

| | | Example 2 | Example 3 | Example 4 | Example 5 |
|---|---|---|---|---|---|
| | Example 1 | (comp.) | (comp.) | (comp.) | (comp.) |
| Blocking | butanone | butanone | butanone | butanone | butanone |
| agent | oxime | oxime | oxime | oxime | oxime |
| Compound | X | — | — | — | X |
| of | | | | | |
| formula (IV) | | | | | |
| Irganox 245 | — | — | X | — | — |
| Tinuvin 765 | — | — | X | — | X |
| Tinuvin 770 | X | — | — | — | — |
| DF | | | | | |
| Adipic acid | — | X | — | — | — |
| dihydrazide | | | | | |
| CIE-LAB*¹⁾ | 4.4 | 6.4 | 5.7 | 9.9 | 5.2 |
| b* values | | | | | |

*¹⁾120 μm wet film after 30 minutes' drying at room temperature and 30 minutes' drying at 170° C.

The crosslinker composition according to the invention of Example 1 (see Table 3) exhibited a significantly improved yellowing-resistance in comparison with those of Examples 2 to 5.

### Example 6 (according to the invention)

963.0 g of a biuret group-containing polyisocyanate prepared from 1,6-diisocyanatohexane (HDI) and having an NCO content of -23.0% were stirred at 100° C. for 30 minutes with 39.2 g of polyether LB 25 (Bayer AG, DE, monofunctional polyether based on ethylene oxide/propylene oxide having a number average molecular weight of 225, OH no. 25) and 7.8 g of the hydrazine adduct of formula IV (reaction product of 1 mole of hydrazine hydrate and 2 moles of propylene carbonate, molecular weight of 236). 493.0 g of ε-caprolactam were then added over a period of 20 minutes such that the temperature of the reaction mixture did not exceed 110° C. Stirring was carried out at 110° C. until the theoretical NCO value was reached, and the mixture was then cooled to 90° C. After adding 7.9 g of Tinuvin® 770 DF (Ciba Spezialitäten GmbH, Lampertheim, Del.) and stirring for a further 5 minutes, a mixture of 152.5 g of hydrophilic agent KV 1386 (BASF AG, Ludwigshafen, Del.) and 235.0 g of water was metered in over a period of 2 minutes, and stirring was continued for a further 7 minutes at neutral temperature. A dispersion was subsequently prepared by the addition of 3341.4 g of water. After stirring for a further 4 hours, an aqueous dispersion that was stable to storage and had a solids content of 29.9% was obtained.

### Example 7 (comparison example):

963.0 g of a biuret group-containing polyisocyanate prepared from 1,6-diisocyanatohexane (HDI) and having an NCO content of 23.0% were stirred at 100° C. for 30 minutes with 39.2 g of polyether LB 25 (Bayer AG, DE, monofunctional polyether based on ethylene oxide/propylene oxide having a number average molecular weight of 2250, OH no. 25). 493.0 g of ε-caprolactam were then added over a period of 20 minutes such that the temperature of the reaction mixture did not exceed 110° C. Stirring was carried out at 110° C. until the theoretical NCO value was reached, and the mixture was then cooled to 90° C. After stirring for a further 5 minutes, a mixture of 152.5 g of hydrophilic agent KV 1386 (BASF AG, Ludwigshafen, Del.) and 235.0 g of water was metered in over a period of 2 minutes, and stirring was continued for a further 7 minutes at neutral temperature. A dispersion was subsequently prepared by the addition of 3325.1 g of water. After stirring for a further 4 hours, an aqueous dispersion that was stable to storage and had a solids content of 30.0% was obtained.

### Example 8 (comparison example):

192.6 g of a biuret group-containing polyisocyanate prepared from 1,6-diisocyanatohexane (HDI) and having an NCO content of 23.0% were stirred at 100° C. with 7.8 g of polyether LB 25 (Bayer AG, DE, monofunctional polyether based on ethylene oxide/propylene oxide having a number average molecular weight of 2250, OH no. 25). 98.6 g of ε-caprolactam were then added over a period of 20 minutes such that the temperature of the reaction mixture did not exceed 110° C. Stirring was carried out at 110° C. until the theoretical NCO value was reached, and the mixture was then cooled to 90° C. After the parallel addition, over a period pf 5 minutes, of 4.1 g of adipic acid dihydrazide, dissolved in 20.0 g of water, and a mixture of 22.4 g of hydrophilic agent KV 1386 (BASF AG, Ludwigshafen, DE) and 47.0 g of water, the reaction mixture was stirred for a further 7 minutes at neutral temperature. A dispersion was subsequently prepared by the addition of 647.8 g of water over a period of 3 minutes. After stirring for a further 4 hours, an aqueous dispersion that was stable to storage and had a solids content of 28.8% was obtained.

### Example 9 (according to the invention):

13.5 g of polyether LB 25 (Bayer AG, DE, monofunctional polyether based on ethylene oxide/propylene oxide having a number average molecular weight of 2250, OH no. 25) and 85.1 g of ε-caprolactam were placed in a reaction vessel and heated to 90° C. with stirring. 193.0 g of an isocyanurate group-containing polyisocyanate prepared from 1,6-diisocyanatohexane (HDI) and having an NCO content of 21.8% were then added over a period of 30 minutes such that the temperature of the reaction mixture did not exceed 110° C. After the addition, stirring was carried out for a further 3 hours at 120° C. 11.1 g of the hydrazine adduct of formula IV (reaction product of 1 mole of hydrazine hydrate and 2 moles of propylene carbonate, molecular weight of 236) were metered in, and stirring was carried out until the theoretical NCO value was reached. 3.1 g of Tinuvin® 770 DF (Ciba Spezialitäten GmbH, Lampertheim, Del.) were then added at 100° C. in 5 minutes, and the reaction mixture was cooled to 80° C. 24.6 g of hydrophilic agent KV 1386 (BASF AG, Ludwigshafen, Del.) were metered in over a period of 2 minutes, and the reaction mixture was stirred for a further 15 minutes. A dispersion was prepared by the addition of 648.1 g of water (T=60° C.) in 10 minutes. Stirring was carried out for a further 2 hours. A dispersion that was stable to storage and had a solids content of 30.0% was obtained.

TABLE 4
ε-Caprolactam-blocked crosslinker compositions containing
different stabilizers

| | | Example 7 | Example 8 | |
|---|---|---|---|---|
| | Example 6 | (comparison) | (comparison) | Example 9 |
| Blocking | ε- | ε- | ε- | ε- |
| agent | caprolactam | caprolactam | caprolactam | caprolactam |
| Polyisocyanate | biuret | biuret | biuret | isocyanurate |
| type | | | | |
| Compund of | X | — | — | X |
| formula (IV) | | | | |
| Tinuvin | X | — | — | X |
| 770 DF | | | | |
| Adipic acid | — | — | X | — |
| dihydrazide | | | | |
| CIE-LAB^{*1)} | 1.3 | 5.3 | 5.0 | 1.4 |
| b* values | | | | |

^{*1)}120 μm wet film after minutes' drying at room temperature and 30 minutes' drying at 170° C.

The crosslinker compositions according to the invention of Examples 6 and 9 (see Table 4) exhibited significantly improved yellowing resistance in comparison with those of Examples 7 and 8.

### Example 10 (according to the invention)

231.1 g of a biuret group-containing polyisocyanate prepared from 1,6-diisocyanatohexane (HDI) and having an NCO content of 23.0% were stirred at 100° C. for 30 minutes with 9.4 g of polyether LB 25 (Bayer AG, DE, monofunctional polyether based on ethylene oxide/propylene oxide having a number average molecular weight of 2250, OH no. 25) and 1.9 g of the hydrazine adduct of formula IV (reaction product of 1 mole of hydrazine hydrate and 2 moles of propylene carbonate, molecular weight of 236). 91.1 g of butanone oxime were then added over a period of 20 minutes at 90° C. such that the temperature of the reaction mixture did not exceed 110° C. Stirring was carried out at 100° C. until the theoretical NCO value was reached, and the mixture was then cooled to 90° C. After adding 1.9 g of Tinuvin® 770 DF (Ciba Spezialitäten GmbH, Lampertheim, Del.) and stirring for a further 5 minutes, a mixture of 36.6 g of hydrophilic agent KV 1386 (BASF AG, Ludwigshafen, Del.) and 56.4 g of water was metered in over a period of 2 minutes, and stirring was continued for a further 7 minutes at neutral temperature. A dispersion was subsequently prepared by the addition of 738.4 g of water. After stirring for a further 4 hours, an aqueous dispersion that was stable to storage and had a solids content of 28.0% was obtained.

### Example 11 (comparative example)

154.1 g of a biuret group-containing polyisocyanate prepared from 1,6-diisocyanatohexane (HDI) and having an NCO content of 23.0% were stirred at 100° C. for 30 minutes with 6.3 g of polyether LB 25 (Bayer AG, DE, monofunctional polyether based on ethylene oxide/propylene oxide having a number average molecular weight of 2250, OH no. 25). 60.6 g of butanone oxime were then added over a period of 20 minutes at 90° C. such that the temperature of the reaction mixture did not exceed 110° C. Stirring was carried out at 100° C. until the theoretical NCO value was reached, and the mixture was then cooled to 90° C. After stirring for a further 5 minutes, a mixture of 22.0 g of hydrophilic agent KV 1386 (BASF AG, Ludwigshafen, DE) and 37.5 g of water was metered in over a period of 2 minutes, and stirring was continued for a further 7 minutes at neutral temperature. A dispersion was subsequently prepared by the addition of 485.5 g of water. After stirring for a further 4 hours, an aqueous dispersion that was stable to storage and had a solids content of 29.8% was obtained.

TABLE 5
Butanoneoxime-blocked crosslinker compositions by comparison

| | | Example 11 |
|---|---|---|
| | Example 10 | (comparison) |
| Blocking | butanone- | butanone |
| agent | oxime | oxime |
| Compund of | X | — |
| formula (IV) | | |
| Tinuvin 770 DF | X | — |
| CIE-LAB^{*1)} | 5.2 | 7.2 |
| b* values | | |

^{*1)}120 μm wet film after 30 minutes' drying at room temperature and 30 minutes' drying at 170° C.

The crosslinker composition according to the invention of Example 10 (see Table 5) exhibited significantly improved yellowing resistance in comparison with Example 11.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A water-dispersible crosslinker composition comprising
A) at least one hydrophilically-modified, blocked polyisocyanate,
B) at least one stabilizing agent comprising
a) at least one amine containing a structural unit corresponding to formula (I) 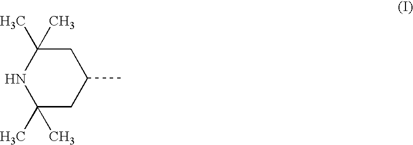
which does not contain hydrazide groups,
b) at least one compound containing a structural unit corresponding to formula (II)
—CO—NH—NH— (II)
and
c) optionally a stabilizing component other than a) and b), and
C) optionally an organic solvent.

2. The water-dispersible crosslinker composition of claim 1 wherein component A) is the reaction product of at least one organic polyisocyanate A1) having aliphatically, cycloaliphatically, araliphatically and/or aromatically bound isocyanate groups, an ionic or potential ionic and/or non-ionic compound A2) and a blocking agent A3).

3. The water-dispersible crosslinker composition of claim 1 wherein component A) has a content of isocyanate groups (unblocked and blocked) of 5.0 to 27.0 wt. %.

4. The water-dispersible crosslinker composition of claim 1 wherein at least 50% of the isocyanate groups of component A) are present in blocked form.

5. The water-dispersible crosslinker composition of claim 1 wherein the water-dispersible crosslinker composition contains 0.1 to 11.0 wt. % of an amines (a) containing the structural unit of formula (I), 0.1 to 11.0 wt. % of a compounds (b) containing the structural unit of formula (II), and 0 to 5.0 wt. % of a stabilizers c), wherein the percentages are based on the total solids content of the crosslinker composition.

6. The water-dispersible crosslinker composition of claim 1 wherein amine a) comprises a compound corresponding to formula (III)

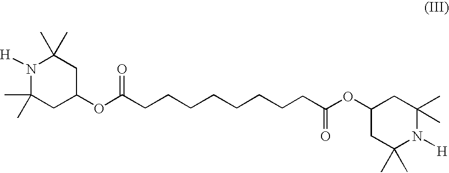

7. The water-dispersible crosslinker composition of claim 2 wherein amine a) comprises a compound corresponding to formula (III)

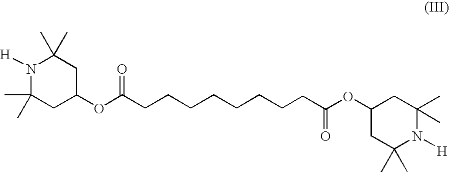

8. The water-dispersible crosslinker composition of claim 5 wherein amine a) comprises a compound corresponding to formula (III)

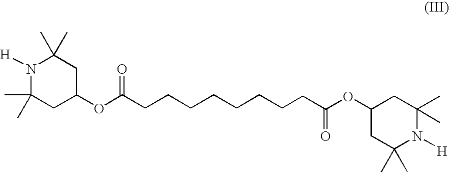

9. The water-dispersible crosslinker composition claim 1 wherein compound b) comprises a compound corresponding to formula (IV)

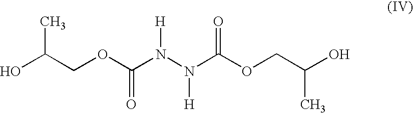

10. The water-dispersible crosslinker composition claim 2 wherein compound b) comprises a compound corresponding to formula (IV)

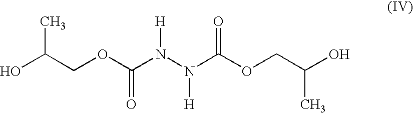

11. The water-dispersible crosslinker composition claim 5 wherein compound b) comprises a compound corresponding to formula (IV)

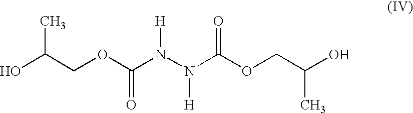

12. The water-dispersible crosslinker composition claim 6 wherein compound b) comprises a compound corresponding to formula (IV)

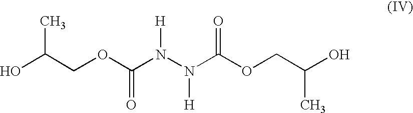

13. The water-dispersible crosslinker composition claim 7 wherein compound b) comprises a compound corresponding to formula (IV)

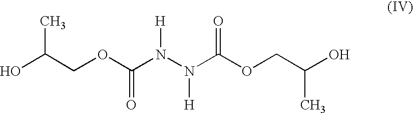

14. The water-dispersible crosslinker composition claim 8 wherein compound b) comprises a compound corresponding to formula (IV).

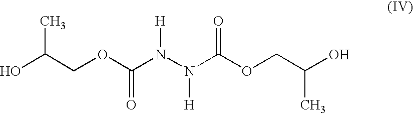

15. An aqueous solution or dispersion containing the crosslinker composition of claim 1 wherein the solution or dispersion has a solids content of 10 to 70 wt. %.

16. The aqueous solution or dispersion of claim 15 wherein the amount of component C) in the solution or dispersion is less than 15 wt. %, based on the total composition.

17. A coating composition containing the crosslinker composition of claim 1.

18. The coating composition of claim 17 which additionally contains a polyurethane and/or polyacrylate dispersion or a polyurethane-polyacrylate hybrid dispersion.

19. A sizing agent for glass fibers containing the crosslinker composition of claim 1.

20. Glass fibers sized with the sizing agent of claim 19.
